(19) United States
(12) Patent Application Publication
(10) Pub. No.: US 2024/0253497 A1
(43) Pub. Date: Aug. 1, 2024

(54) CONNECTION DEVICE FOR AN ELECTRIC VEHICLE

(71) Applicant: Weidmüller Interface GmbH & Co. KG, Detmold (DE)

(72) Inventors: Matthias BÖNSCH, Bielefeld (DE); Constantin CLASSEN, Detmold (DE)

(21) Appl. No.: 18/561,212

(22) PCT Filed: May 17, 2022
(86) PCT No.: PCT/EP2022/063346

§ 371 Date: Nov. 15, 2023

(30) Foreign Application Priority Data
May 19, 2021 (DE) 10 2021 112 985.0

(51) Int. Cl. B60L 53/31; B60L 53/16; B60L 53/66; H02J 7/00

(52) U.S. Cl. CPC B60L 53/31; B60L 53/16; H02J 7/0042; B60L 53/665

(57) ABSTRACT

A connection device for connecting an electric vehicle for a charging process includes at least one receiving profile which is open to one side for receiving at least one module, wherein one side of a housing of the module forms part of an outer surface of the connection device.

### BACKGROUND OF THE INVENTION

The invention relates to a connection device for connecting an electric vehicle for a charging process.

Electric vehicles are connected to a direct or alternating current supply line in order to charge the drive battery for driving operation. For this purpose, connection devices are employed, mostly in the form of cabinets or columns, which are set up in the private or public traffic sphere and to which electric vehicles can be connected for charging. Such connection devices are generally mounted on a wall in the form of cabinets and are referred to as “wall boxes”. Charging columns are normally freestanding.

Depending on the requirements of the users and/or the installers or operators of the connection devices, these are equipped with a wide range of functionalities. Alongside the basic function of providing power to charge the vehicle batteries, different authorization methods can be employed. In the private sphere, it can be envisaged for the connection device to be used at any time and without prior authorization. If desired, it is possible to provide restricted access here too, for security reasons. In public areas, use is generally only possible after prior authorization, for which different technologies such as key-operated switches, contact-based or contactless chipcard authorization or remote authorization via network mechanisms or even biometric sensor technology can be employed. In addition, use can be linked to a billing technology which can also be accomplished in a variety of ways. Depending on the location and planned use, supplementary functionalities can be desired, such as backlighting or the provision of power outlets other than those required for the actual charging function. There are also different ways of how the electric vehicles are connected to the connection device. For instance, a plug socket for plugging in the charging cable can be arranged in the connection device. Alternatively, charging cables can be connected directly and firmly to the connection device. With regard to the plugging connection between the charging cable and the vehicle, there are different plug types, which are dependent on, amongst other things, the nature of the current (direct current or alternating current) and the available power.

The variety of different connection devices leads to high development, production and storage expense for manufacturers of such connection devices. In addition, for users, the requirements can change with regard to the charging technology itself, but also with regard to the additional equipment of the connection devices over time by new users and/or other vehicle types. However, there is no, or only very limited, convertability for known, firmly configured connection possibilities.

There is thus a need to create a connection device which is configured as flexibly as possible and which can be subsequently altered or and/or expanded without difficulty.

### SUMMARY OF THE INVENTION

Accordingly, it is an object of the present disclosure to provide a connection device having a receiving profile which is open to one side for receiving at least one module, wherein one side of a housing of the module forms part of an outer surface of the connection device.

Through the modules which can be inserted into the receiving profile, a flexible configuration and ability to be converted or retrofitted is achieved. Different modules can be provided which can be combined such that the connection device provides the desired functions. Modules can have an operating unit, can function as a control unit, can provide a plug socket for connecting a suitable charging cable or can also comprise power meters.

The modules or their housings form part of the outer surface of the connection device. It is thus possible to achieve a particularly simple mechanical design. The receiving profile and the inserted module, or the inserted modules themselves, form the housing of the connection device. The receiving profile preferably has a u-shaped or c-shaped cross-section and can be used in any length desired, which is dictated by the number of modules inserted into the profile, one behind the other (in the longitudinal direction of the profile). The modules then fill in the open longitudinal side of the profile providing a front plate with operating elements or plug sockets. If the entire receiving profile is not occupied by functional modules, empty modules or screens can be inserted. One end or both ends of the receiving profile can likewise be closed by screens or other termination members.

Preferably, the modules are attached, e.g. screwed, in a concealed manner in the at least one receiving profile.

In one advantageous configuration, the connection device is formed as a battery charging station, in that it has two receiving profiles, which adjoin one another with their open sides pointing in opposite directions. The receiving profiles adjoin one another to a certain extent back-to-back and complete one another to form an approximately cylindrical column. A module or modules can be arranged on both sides. In an alternative configuration, two receiving profiles are provided which point by their open sides in opposite directions, but not back-to-back. Rather, these are spaced apart from one another, wherein the free space between them is clad by side walls which, for example, can serve as advertising boards or information walls. A screen can also be arranged in the side wall, in order to depict content in a flexible and interactive manner. In an alternative configuration, the connection device can have a wall-mounted receiving profile which is either sunk into a wall or mounted onto a wall. Such a connection device then represents a “wall box”.

In an additional advantageous configuration of the connection device, the at least one module has a plug-in connector on at least one additional side of the housing, in order to electrically contact a module adjacently inserted into the receiving profile. The plug-in connector is preferrably arranged on a side of the module housing which points in the longitudinal direction of the receiving profile. A module can then be inserted into the profile and be displaced in the direction of a previously inserted module, such that their plug-in connectors can be plugged into one another and thus an electrical connection of module to module is constructed. For this purpose, plug-in connectors are preferably arranged at two opposite sides of module housings. The plug-in connectors are in each case formed in pairs as plugs and sockets, to be concealed with one another. The plug-in connectors preferably have contacts for an operating current, contacts for data and/or signals. The contacts for an operating current can have a high current carrying capacity appropriate for a transmitted charging current for the electric vehicle. The number of contacts can be selected as required. For the operating current, at least five contacts are sensible to also provide, alongside three phase conductors, a neutral conductor and a grounding.

More preferably, two plug-in connectors in each case are electrically connected to one another on opposite sides of modules, so that a current path is formed inside the modules. The connection can be designed directly, with the current path inside the module possibly being diverted, but otherwise not manipulated. However, it can also be envisaged that switching elements, fuse elements or the like, which switch or interrupt one or more conductors of the current path, are arranged in a module.

In an additional advantageous configuration of the connection device, two plug-in connectors are arranged on each of the additional sides of the housing of the module. At least two, and where necessary several, modules can be arranged one behind the other, in the longitudinal direction of the receiving profile, and can be connected to one another via the plug-in connectors. Through the plug-in connectors being arranged facing one another, the modules are mechanically strung together, which leads, without additional installation expense, to an electrical connection between the modules. Two independent current paths are preferably formed inside the module between respective plug-in connectors on opposite sides of the housing. Preferably, the two current paths cross inside the module. If, for example, the plug-in connectors on the opposite sides are arranged alongside one another, then a first current path runs from a left plug-in connector (viewed from the front, i.e. looking towards the open side of the profile or a front of the module) at one end of the module to a right plug-in connector at the opposite end of the module. As a result, it is possible to arrange two identically configured modules (e.g. two modules, each with one plug socket which is connected to one of the plug connectors) one behind the other, with the modules, despite their identical configuration, relating to the respective other current path.

In an additional advantageous configuration of the connection device, the at least one plug-in connector is attached in the housing with lateral play. For this, the plug-in connector has a plug-in body in which at least one contact is arranged. The plug-in body has a circumferential edge which is inserted into a groove of the housing of the module. The groove can be configured to be oversized compared to the edge, as a result of which the desired lateral play is possible. The play compensates for tolerances and temperature expansions. In order to guarantee easy pluggability despite this play, spring arms are provided, which position the plug-in body in the groove and which stick out on the circumferential edge of the plug-in body.

### BRIEF DESCRIPTION OF THE DRAWINGS

The invention will be explained in greater detail below using exemplary embodiments with the aid of figures. In the figures:

FIGS. 1a and 1b are side views of a first embodiment of a connection device according to the present disclosure;

FIG. 2 is an exploded side view of the connection device of FIGS. 1a and 1b;

FIG. 3 is a plan view of the connection device according to FIGS. 1a and 1b during the insertion of modules;

FIG. 4 is an isometric view of the connection device according to FIGS. 1a and 1b during the insertion of modules;

FIG. 5 is an isometric view of the connecting region of two modules with an opened module housing;

FIG. 6 is an isometric view of a separated plug and socket of a module;

FIGS. 7a and 7b are side views of modules in a battery charging station and a circuit diagram for these modules, respectively;

FIGS. 8a-8c are perspective views of additional exemplary embodiments of connection devices;

FIG. 9 is a perspective view of an additional exemplary embodiment of a connection device;

FIGS. 10a-10c are perspective, side and exploded views, respectively, of an additional exemplary embodiment of a connection device; and

FIGS. 11a and 11b are perspective and exploded views, respectively, of an additional exemplary embodiment of a connection device.

### DETAILED DESCRIPTION

The figures described below depict various exemplary embodiments of connection devices. Identical reference numbers denote identical or identically acting elements in all figures. For the sake of clarity, not all elements are equipped with reference numbers in all figures.

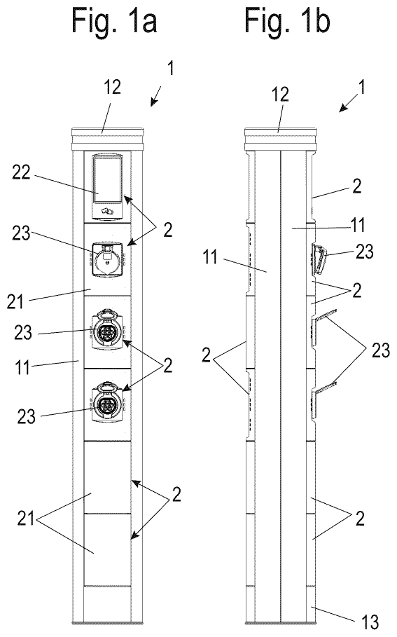

FIGS. 1a and 1b show a first exemplary embodiment of a connection device 1 in two different side views. FIG. 1a shows a front side view of the connection device 1 and FIG. 1b shows a side surface view of the connection device 1. The connection device 1 is formed as a battery charging station in this first exemplary embodiment. For the sake of simple depiction, the connection device 1 is also referred to as “battery charging station 1” below.

The battery charging station 1 comprises two vertical receiving profiles 11, the upper ends of which are covered by a termination member 12. At their lower end, the receiving profiles 11 are attached to a mounting foundation, not shown here. The receiving profiles 11 are open at their lower end, such that power supply lines and, where applicable, data lines can be guided into the battery charging station 1 from the foundation.

As will be explained in greater detail below, the receiving profiles 11 have an approximately c-shaped cross-section, with a “back” of the profiles being straight, such that the two receiving profiles 11 can adjoin one another planarly, back-to-back, in order to form the battery charging station 1. On the opposite side, each of the receiving profiles 11 is open and forms a receiving region for modules 2.

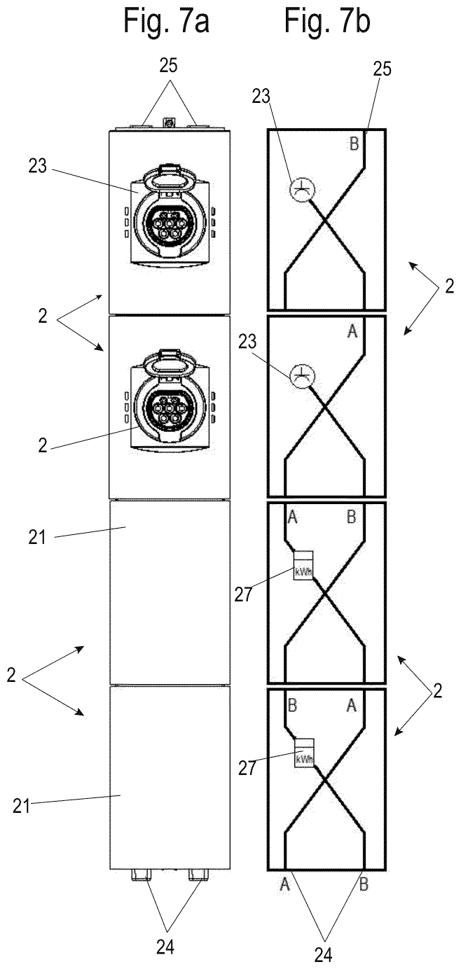

To configure the battery charging station 1 individually, different modules 2 are provided which can optionally be inserted on both sides of the battery charging station 1. The modules 2 have a housing 26 with a front plate 21, into which an operating unit 22 or a plug socket 23 is inserted. The module 2 with the operating unit 22 which is uppermost in the battery charging station 1 serves the controlling and/or authorising of a charging process. The modules 2 with the plug sockets 23 provide connection points for electric vehicles, which can be inserted in an alternating or, with an appropriate configuration of the battery charging station 1, parallel manner. The plug sockets 23 can be designed as Type-2 plug sockets according to IEC Standard 62196. The modules 2, which are arranged in the lower region of the battery charging station 1 and in which only the front plate 21 is visible, can be either empty modules or modules which have functional electrics or electronics which cannot be seen and operated, or cannot be seen and operated by a user, for example fuses or other protective devices or power meters (FIG. 7).

Alongside empty modules, screens 13 can be used to close up the receiving profile 11 in regions which are not required.

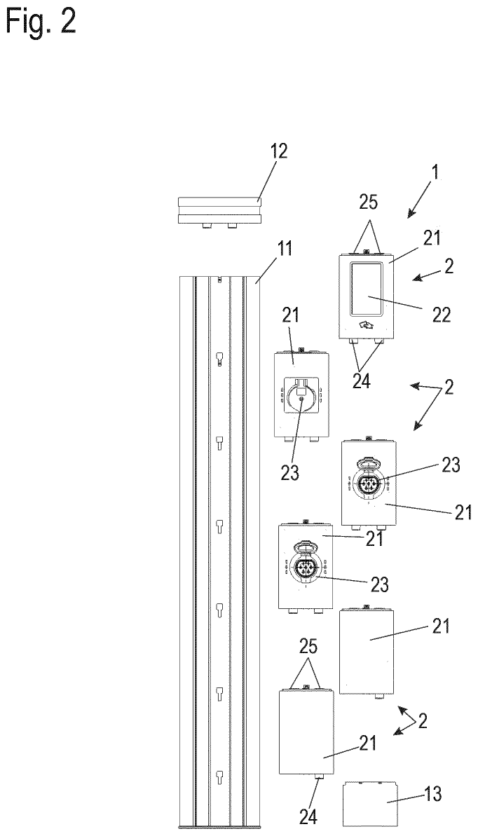

In FIG. 2, analogously to FIG. 1b, the battery charging station 1 is shown in a front side exploded view in which the different modules 2 and the termination member 12, as well as the screen 13, are depicted in an unmounted manner beside or above the battery charging station 1.

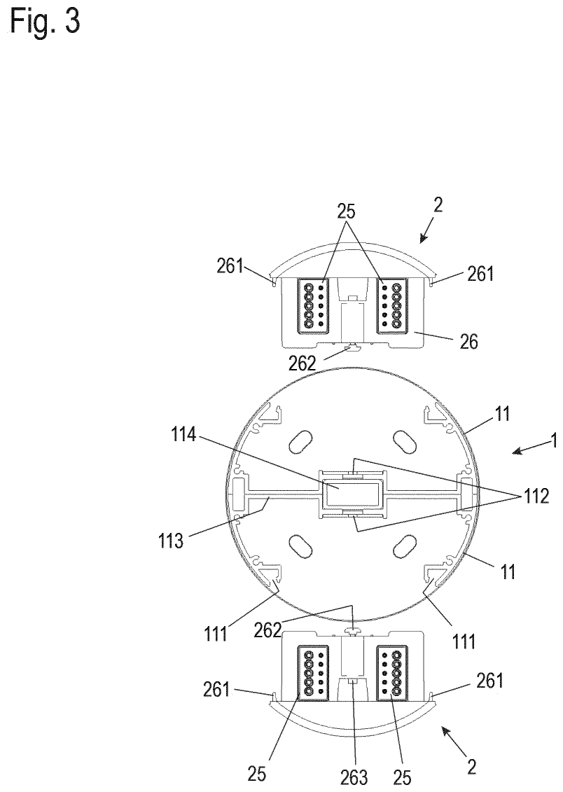

FIG. 3 shows a plan view of the battery charging station 1 (without the termination member 12), and two modules 2 before insertion into the battery charging station 1.

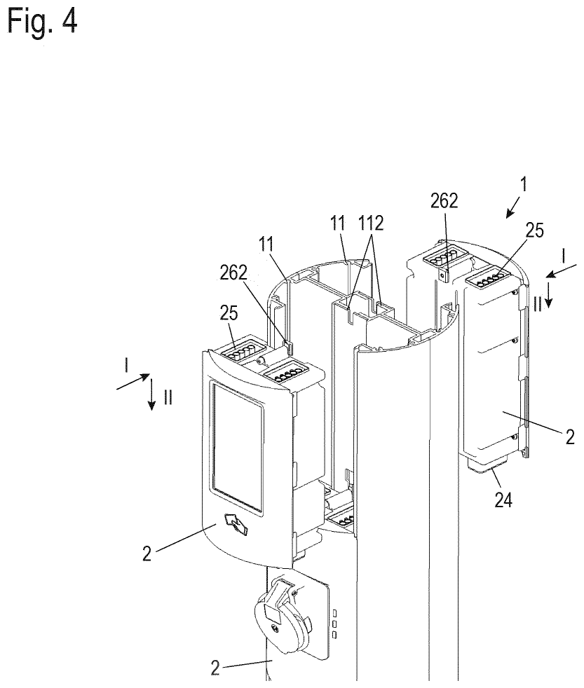

FIG. 4 is an isometric view showing installation of two modules 2 into the battery charging station 1. FIGS. 2-4 show the attachment of the modules 2 in the battery charging station 1 and the insertion process in a more detailed manner.

As described above, the receiving profiles 11 each have an approximately C-shaped cross-section, as a result of which a receiving space for the modules 2 is formed. On the receiving profile 11 guiding slots 111 are formed, into which corresponding protrusions on module housings 26 of the modules 2 can engage. In the guiding slots 111 or on the protrusions 161 sealing strips can be positioned, which impede the ingress of moisture and/or dirt into the interior of the receiving profile 11. The rear side of the receiving profiles 11, i.e. the side opposite a receiving aperture, is substantially straight, such that the two receiving profiles 11 can be put together back-to-back in a planar manner. In the present example, the receiving profiles 11 are formed at their sides such that, together with the front plate 21 which is also curved, they complete one another to form a full circle. The battery charging station 1 thus has a circular cross-section. On the modules, the front plate 21 can be curved over its entire height or only in sections. Flat regions can also be provided, on which the operating unit 22 or plug socket 23 can be mounted more easily.

Furthermore, grooves 112, in which one slot stone 262 of a module 2 engages, are arranged at regular spacing in the back region of the receiving profiles 11. In the present example, the grooves are widened in the upper region, so that the slot stone 262 can be inserted—in a manner comparable to a keyhole receptacle. The module 2 is inserted in direction of movement A, as symbolised by a movement arrow in FIG. 4. The module 2 is therefore first inserted into the battery charging station 1 perpendicularly thereto, such that the slot stone is inserted into the enlarged aperture. The module 2 is then moved downward in direction of movement B until the slot stone 262 is inserted into the groove 112. The slot stone 262 is connected by a clamping screw 263 which is guided through a receptacle in the module housing 26. Tightening this clamping screw 263 tightens the slot stone 262 onto the module housing 26 and thus fixes it, in its upper region, to the rear wall of the receiving profile 11. In this manner, the modules 2 can be mounted successively from the lowest to the uppermost in the battery charging station 1. In the present case, each module 2 is attached in the lower region indirectly to the receiving profile 11 via the interacting plug-in connectors 24, 25 to the module housing 26 situated below, and in the upper region directly via the slot stone 262. Alternatively or additionally, a direct attachment to the receiving profile 11 can be supplied in the lower region.

In the depicted example, the receiving profile 11 is protrudingly formed in the back region in which the grooves 112 are formed, such that a free channel 114 is formed between both receiving profiles 11. This can be used as a cable channel or the like, for example to guide the cable into the upper termination member 12.

The modules 2 are coupled to power supply cables, data and/or signal cables via interacting plug-in connectors 24, 25 respectively formed on the upper side and underside of the module housings 26. For the sake of simpler depiction, the plug-in connectors 24 provided on the underside will also be referred to below as “plug 24” and the plug-in connector 25 arranged on the upper side of the module housings 26 will also be referred to below as “sockets 25”. It will be understood by those with skill in the art that the arrangement and distribution in plugs and sockets can be formed differently from this without deviating from the spirit and scope of the disclosed invention. The only important consideration is that, when assembling the battery charging station 1, plugged-together modules 2 in each case have contacts which fit one another appropriately in pairs.

The plug-in direction of a plug 24 and socket 25 is along the vertical longitudinal axis of the battery charging station 1 and thus parallel to the displacement direction according to the displacement arrow B in FIG. 4. When the slot stones 262 are inserted into the groove 112, the plugs 24 of the module 2 to be inserted is plugged into the sockets 25 of the underlying module 2 which has already been inserted. Thus, in parallel with the mechanical placement of the modules 2 onto one another, the electrical contacting of them is also successively built from the bottom upward.

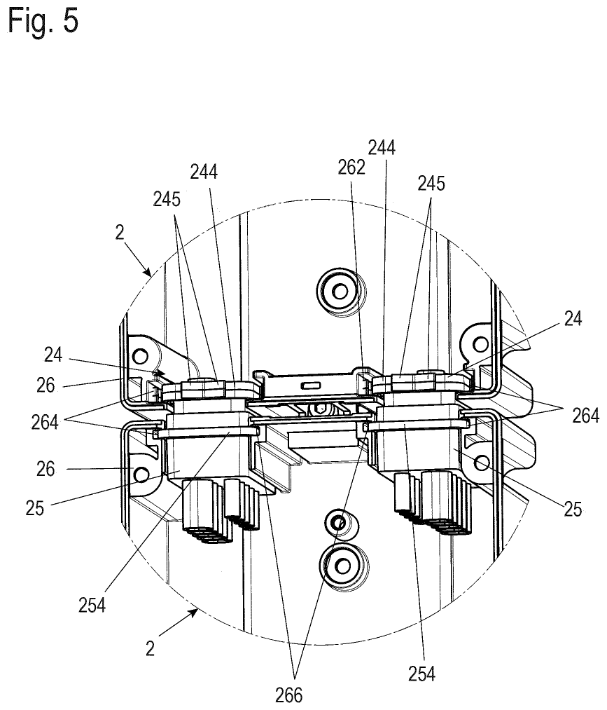

FIG. 5 shows sections of modules 2 arranged over one another in their connecting region with a front part (pointing towards the operator) of the respective module housing 26 being removed. This shows the region in which the plugs 24 of the upper module 2 are plugged into the sockets 25 of the lower module 2.

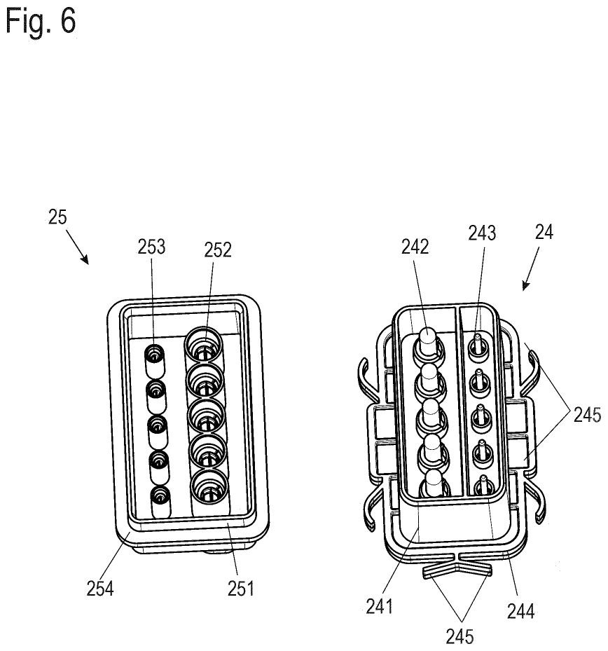

The sides of the plugs 24 and socket 25 which point toward one another are also depicted separately beside one another in FIG. 6.

The plug 24 has a plug housing 241, which has five contacts 242 for transmitting higher currents, for example from three-phase alternating current with which the battery charging station 1 is operated. Furthermore, there are five contacts 243 for data and signals. The quantity of five contacts 242 and 243 respectively is purely by way of example and can vary in other forms of the modules 2. Analogously, the socket 25 has a housing 251, contacts 252 for higher currents and contacts 253 for data and/or signals.

Both housings 241, 251 have a circumferential edge 244 and 254 respectively which serves to fix the plug 24 or the socket 25 in the module housings 26. For this purpose, these have a guide with a groove 264 into which the plug 24 and socket 25 are inserted by their respective circumferential edge 244, 254. A cover, not depicted in FIG. 5, of the module housing 26 completes the groove 262, such that the plug 24 and socket 25 are circumferentially gripped at their respective circumferential edges 244, 254 by the groove 264. Play is therefore provided such that at least one of the two plugging partners, either the plug and/or socket 25 has lateral play in the groove 264. In this way, it is possible to compensate for tolerances in the precise positioning of the modules 2 inside the receiving profile 11. Different thermal expansions of different modules 2 or different sides of the modules 2 can also be absorbed, in particular through direct sun radiation onto the battery charging station 1.

In order to achieve suitable positioning of the plugs 24 relative to the sockets 25 when inserting the modules 2 into the battery charging station 1, spring arms 245, which are supported on the base of the groove 264 and which bring about centering of the plug 24 in the groove, are laterally arranged on the circumferential edge 244 of the plug 24. Such spring arms 245 are particularly advantageous with the plug-in connector 24, 25 which has lateral play in the groove 264.

FIG. 7a shows a front view of four modules 2 of a battery charging station or of a connection device 1 generally. Receiving profiles in which the modules are arranged are not depicted here.

In FIG. 7b, the modules 2 are represented in an identical arrangement through schematic functional block diagrams. The functional block diagrams indicate the functionality of the individual modules 2, for example in the upper two modules through the wiring symbol of plug socket 23. The lower two modules 2 each have a power meter 27 which measures the amount of power supplied to a module 2 with plug socket 23 and outputs captured data via signal or data lines (for example via the contacts 243 and 253).

In the modules 2 of this exemplary embodiment, as in the case of the modules 2 described above, two plugs 24 are arranged on the upper side and two sockets 25 are arranged on the lower side. Because there are duplicates of the plugs 24 and sockets 25, two current paths A, B are formed independently of one another. In current path A, the upper of the power meters 24 is connected to the upper of the plug sockets 23. In current path B, the lower of the power meters 24 is connected to the lower of the plug sockets 23.

The current paths A, B run in a crossed manner inside of each module 2, such that the left plug 24 in each case is connected to the right socket 25 and the right plug 24 is connected to the left socket 25. As a result, the modules 2 with the power meter 27 can be arranged in the lower region of the connection device 1 and the modules 2 with the plug sockets 23 can be arranged in the upper region of the connection device 1. Moreover, they are formed identically in each case and there nevertheless arises a 1:1 allocation of one of the power meters 27 to one of the plug sockets 23. The modules 2 with identical functionality, i.e. the modules equipped with a power meter 27 and the modules equipped with a plug socket 23 respectively here, need not be offered in two different forms by the manufacturer. If the current paths A, B were to run not in a crossed manner but rather in parallel through the modules 2, it would be necessary to offer two variants to the same: one in which the power meter 24 and plug socket 23 respectively are coupled to the left plug 24 and the left socket 25 and one in which the linking takes place to the right plug 24 and socket 25 respectively.

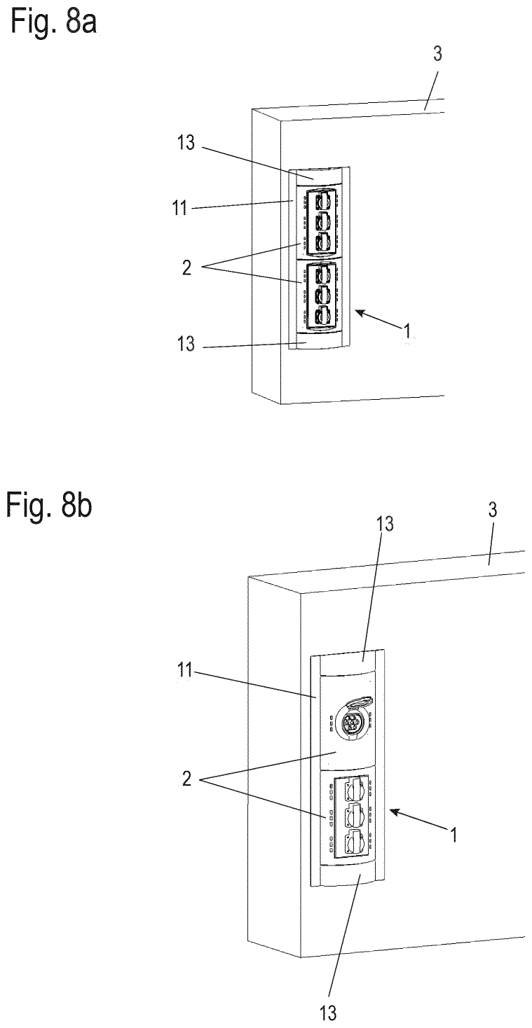

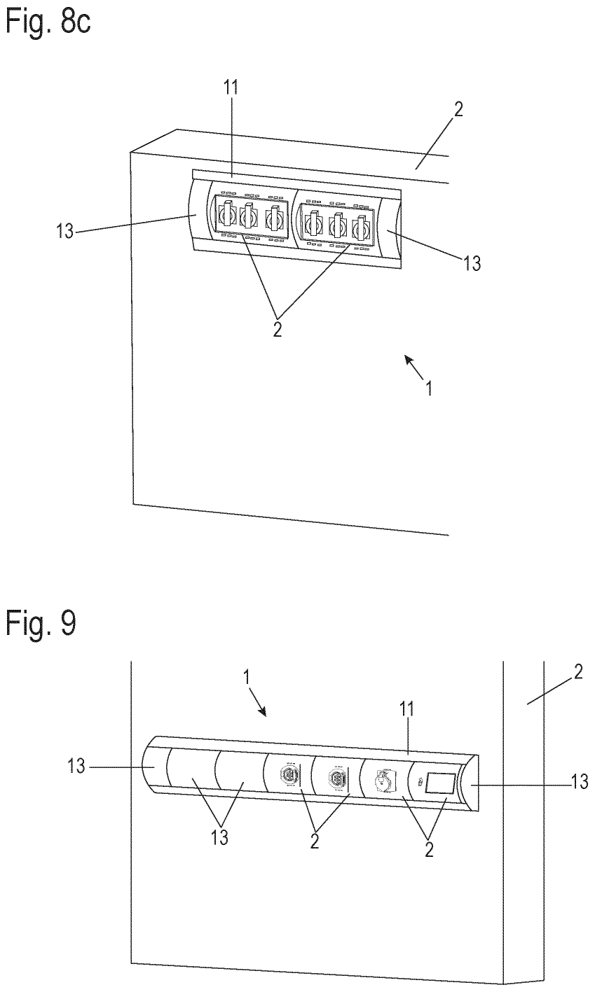

FIGS. 8a-8c show an isometric view of a further exemplary embodiment of a connection device 1 in various assemblies with modules 2 or different mounting orientations.

In all three cases, the connection device 1 is sunk into a depression in a wall 3. It has in each case a receiving profile 11 that, comparable to the receiving profile 11 of the previously shown exemplary embodiments, is suitable to receive one or more modules 2. Attaching the modules 2 in the receiving profile 11 and contacting modules 2 to one another are as described in the previous embodiments. The receiving profile 11 may be provided in different lengths or can be cut to length prior to installation, such that assemblies of varying scope with modules 2 are possible.

FIGS. 8a and 8c show a form of the connection device 1, in which two modules 2 in each case are provided with a multiplicity of plug sockets 23, e.g. CEE plug sockets or Schuko plug sockets. The connection device 1 is arranged vertically in the wall 3 in the example of FIG. 8a, and horizontally in the example of FIG. 8c. The two modules 2 are in each case inserted directly adjacent to one another into the receiving profile 11. Termination screens 13 are provided to the side.

Two modules 2 are likewise inserted in the example of FIG. 8b, one of which depicts three plug sockets with a smaller form factor (as in FIGS. 8a and c) and one of which depicts a Type-2 charging plug socket.

FIG. 9 shows an additional connection device 1 suitable for wall mounting. In contrast to the exemplary embodiments of FIGS. 8a to 8c, in FIG. 9 a receiving profile 11 is not sunk into a wall 3 but rather is mounted onto the wall 3 (“surface mounting”). Purely by way of example, the receiving profile 11 is formed longer here, such that it comprises six modules 2 and lateral screens 13. The connection device 1 horizontally mounted in FIG. 9 is also mountable in a perpendicular arrangement. If necessary, only plug sockets 23 have to be rotated with regard to their orientation within a module 2 for this purpose. In the case of the control module arranged on the right in the receiving profile in FIG. 9, a position sensor can be provided which automatically adapts a display onto the available screen to the orientation of the connection device 1. Alternatively, manual setting are possible for this purpose.

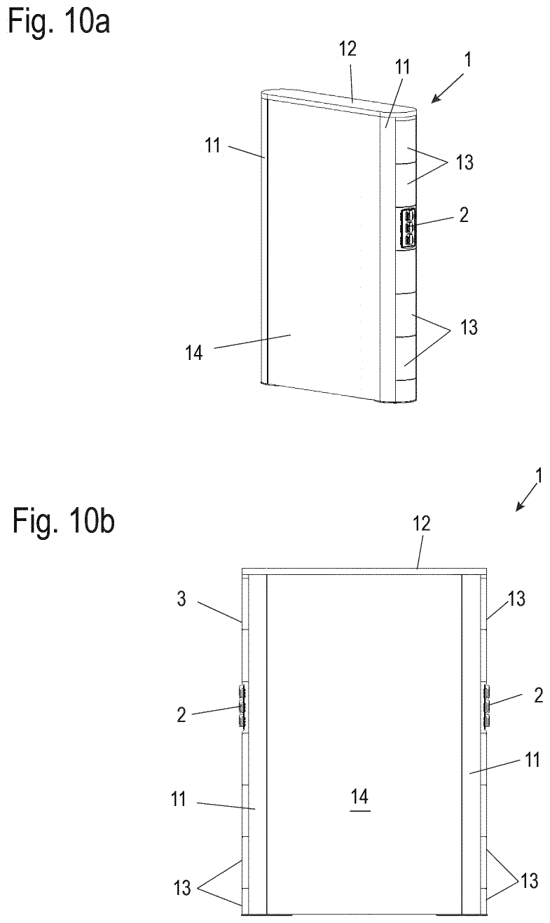

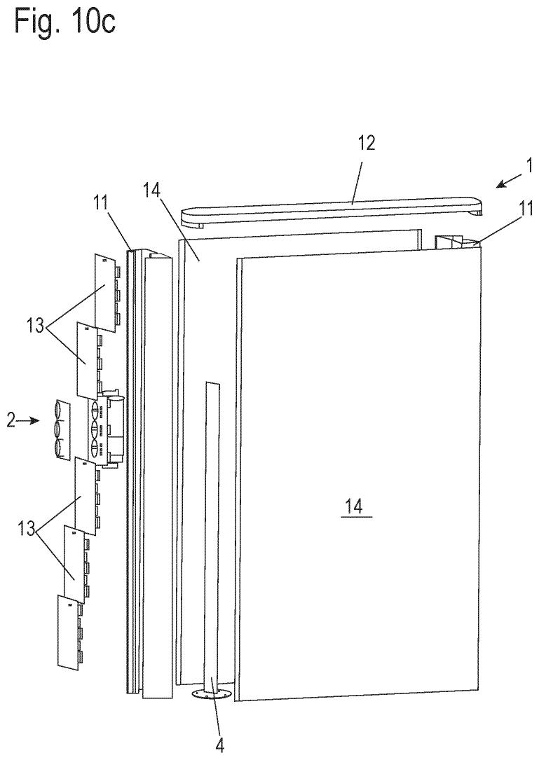

FIGS. 10a-10c show different depictions of an additional exemplary embodiment of a connection device 1, including an isometric view, a side view, and an isometric exploded view, respectively.

The connection device 1 of this exemplary embodiment is similar to the one shown in FIGS. 1-4 in that there is a free-standing column with two receiving profiles 11 with backs that face each other. In contrast to the exemplary embodiment of FIGS. 1-4, in which the two receiving profiles 11 adjoin one another back-to-back, the backs of the receiving profiles 11 are clearly spaced apart from one another in the present exemplary embodiment. The intermediate space between these is closed off to the sides by side walls 14 and is upwardly covered by a termination member 12 which is formed in an elongate manner. This connection device 1 makes advertising surfaces available, in the form of the side walls 14, in particular for public space. The side walls 14 can be transparent and can be illuminated by a light source located between the side walls 14 or they also could include a screen.

If a multiplicity of modules 2 are inserted into the receiving profiles 11, they can be plugged onto one another and, as in the case of the embodiment of FIGS. 1-4[,] can form a continuous current path which if necessary is crossed inside the modules. Alternatively, it can be envisaged, as in the embodiment of FIGS. 10a-10c, that only individual modules 2 are arranged at a particular height. For base-mounting of the connection device 1, vertical supports 4 can be mounted on the base or be sunk in a foundation into the base, to which the receiving profiles 11 can be connected, preferably screwed.

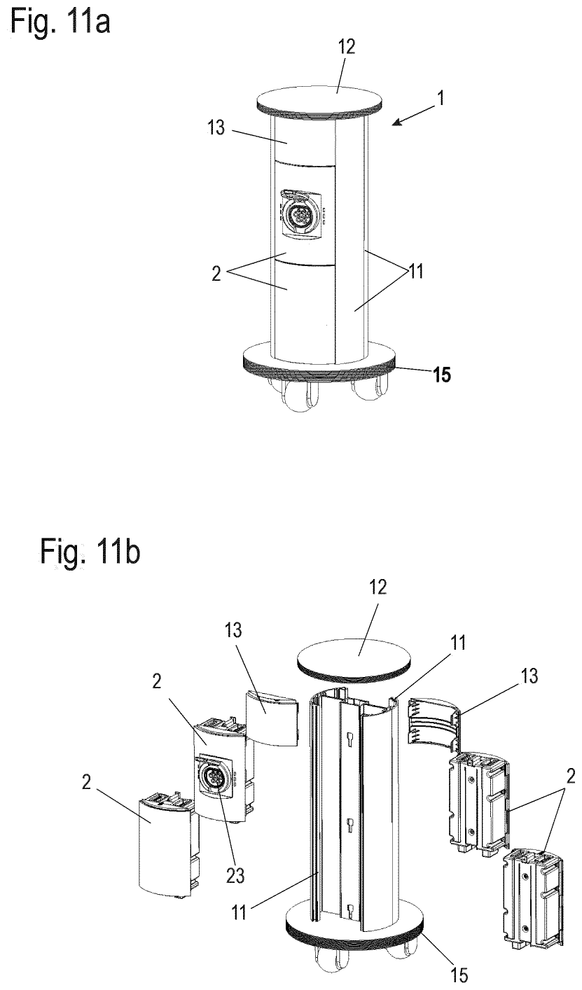

Finally, FIGS. 11a and 11b depict an additional embodiment of a connection device 1 which is a mobile battery charging station. The basic design corresponds to the battery charging station 1 from the embodiment of FIGS. 1-4. As in those, two receiving profiles 11 adjoining one another back-to-back are provided, into which the different modules 2 or screens 13 are inserted. At the top, a termination member 12 terminates the battery charging station.

The two receiving profiles 11 are mounted on a rolling frame 15 which is equipped with at least three rollers in order to roll the connection device 1 to a vehicle to be loaded, e.g. in a car park.

The configuration of the different modules 2, including the receiving profiles 11 and nature of the attachment of the modules 2 to or in the receiving profile 11, are as with those detailed in the first embodiment of FIGS. 1-4.

1. A connection device for connecting an electric vehicle for a charging process, comprising at least one receiving profile open at one side for receiving at least one module, wherein the at least one module includes a housing having a first side configured to form part of an outer surface of the connection device when received by the receiving profile.

2. The connection device according to claim 1, wherein the at least one module has a plug-in connector on at least one additional side of the housing to electrically contact an adjacent module inserted into the receiving profile, the adjacent module including a housing having a first side and a plug-in connector on at least one additional side.

3. The connection device according to claim 2, wherein the plug-in connectors are arranged on opposing sides of their respective module housing.

4. The connection device according to claim 2, wherein the modules each include two plug-in connectors arranged on the at least one additional side of their respective housing.

5. The connection device according to claim 4, wherein when the modules are connected to one another via the plug-in connectors they are arranged one behind the other viewed in the longitudinal direction of the receiving profile.

6. The connection device according to claim 4, wherein one of the plug-in connectors of one module is connected to one of the plug-in connectors of the opposing module such that a current path is formed.

7. The connection device according to claim 4, wherein two independent current paths are formed between respective plug-in connectors on opposite sides of the module housings.

8. The connection device according to claim 7, wherein the two independent current paths intersect inside at least one module.

9. The connection device according to claim 2, wherein the plug-in connector is configured in the housing with lateral play.

10. The connection device according to claim 9, wherein the plug-in connector has a plug-in body having at least one contact therein, the plug-in body having a circumferential edge inserted into a groove of the module housing.

11. The connection device according to claim 10, wherein spring arms stick out on the circumferential edge and position the plug-in body in the groove.

12. The connection device according to claim 2, wherein the plug-in connector comprises contacts for at least one of an operating current, contacts for data, and signals.

13. The connection device according to claim 1, wherein the receiving profile has a u-shaped or c-shaped cross-section.

14. The connection device according to claim 1, wherein the at least one module is concealably screwed into the at least one receiving profile.

15. The connection device according to claim 1, wherein the connection device is configured as a battery charging station having two receiving profiles adjoining one another such that their open sides open in opposite directions.

16. The connection device according to claim 1, including a wall-mountable receiving profile.

17. The connection device according to claim 1, wherein the module has at least one of an operating unit, a plug socket or a power meter.
